(19) United States
(12) Patent Application Publication
(10) Pub. No.: US 2007/0012847 A1
(43) Pub. Date: Jan. 18, 2007

(54) Hanger assemblies and brackets therefor

(76) Inventor: Jen-Lung David Tai, Glendale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/170,834

(22) Filed: Jun. 30, 2005

(51) Int. Cl. E04G 25/00; B42F 13/00

(52) U.S. Cl. 248/343; 248/200.1

(57) ABSTRACT

A hanger assembly includes a tubular member attached to a first joist bracket and which is severed along a length thereof forming an end gap therein. An insert is attached to a second joist bracket and extends into and through the tubular member. The tubular member is movable into a collapsed configuration in response to a force applied thereto at least partially closing the end gap grippingly securing the insert extending therethrough. A hanger bracket has a central portion overlying the elongate tubular member and opposing ends affixed to a junction box, and the central portion of the hanger bracket applies the force to the tubular member.

### FIELD OF THE INVENTION

The present invention relates to hanger assemblies for suspending heaving objects such as ceiling fans and light fixtures.

### BACKGROUND OF THE INVENTION

Inter-joist hangers are used to secure a load between joists disposed on the underside of a ceiling. Numerous hanger assemblies are known for installation of comparatively light loads, and also for heavier loads, with the major difference between the hanger assemblies being primarily the size of the hanger assemblies, in which the small ones are used for small loads and the large ones are used for larger loads.

The main problems in the art of inter-joist hangers are, and since the advent thereof always have been, how to properly and safely support heaving loads and how to properly support heavier loads when access to the space above the ceiling between the joists is not readily available. Although skilled artisans have developed numerous hanger assemblies and various techniques and specialized equipment for installing hanger assemblies, current efforts continue to be not entirely satisfactory as it has been noticed that existing hanger assemblies are difficult to construct and install, difficult to assemble, expensive, and are difficult to remove after installation. Given these and other deficiencies prevalent in the art, the need for certain new and useful improvements is evident.

### SUMMARY OF THE INVENTION

According to the invention, a hanger assembly includes a tubular member attached to a first joist bracket and severed along a length thereof forming an end gap therein. An insert is attached to a second joist bracket and extends into and through the tubular member. The tubular member is movable into a collapsed configuration in response to a force applied thereto at least partially closing the end gap grippingly securing the insert extending therethrough, according to the principle of the invention.

In a further embodiment, a hanger bracket couples a junction box to the tubular member. The hanger bracket has a central portion overlying the elongate tubular member at the end gap and opposing ends affixed to the junction box, and the central portion applies the force to the tubular member, in accordance with the principle of the invention.

In yet another embodiment of the invention, one of a first key and a first keyhole is carried by the first joist bracket, and the other of the first key and the first keyhole is carried by the tubular member, in which the first key is received in the first keyhole detachably securing the first joist bracket to the tubular member. There is also one of a second key and a second keyhole is carried by the second joist bracket, and the other of the second key and the second keyhole is carried by the insert, in which the second key is received in the second keyhole detachably securing the second joist bracket to the insert.

Preferably, the first joist bracket includes a first coupling attached to the tubular member, and a first joist attachment fixture is engagable to the first coupling in a retracted position relative to the first coupling and an extended position relative to the first coupling. In one embodiment, the first joist attachment fixture is engaged to the first coupling in the retracted position. In another embodiment, the first joist attachment fixture is engaged to the first coupling in the extended position. Like the first joist bracket, the second joist bracket includes a second coupling attached to the insert, and a second joist attachment fixture is engagable to the second coupling in a retracted position relative to the second coupling and an extended position relative to the second coupling. In one embodiment, the second joist attachment fixture is engaged to the second coupling in the retracted position. In another embodiment, the second joist attachment fixture is engaged to the second coupling in the extended position.

In yet still another embodiment, the first and second joist brackets are affixed to opposing joists positioned on an underside of a ceiling, and the first and second joist brackets have first and second extensions, respectively, positioned against the underside of the ceiling. In this embodiment the first joist bracket has a first base attached to the tubular member, and the first extension is engagable to the first base in a retracted position relative to the first base and an extended position relative to the first base. In one embodiment, the first extension is engaged to the first base in the retracted position. In another embodiment, the first extension is engaged to the first base in the extended position. Like the first joist bracket in this particular embodiment, the second joist bracket has a second base attached to the tubular member, and the second extension is engagable to the second base in a retracted position relative to the second base and an extended position relative to the second base. In one embodiment, the second extension is engaged to the second base in the retracted position. In another embodiment, the second extension is engaged to the second base in the extended position.

Consistent with the foregoing summary of the invention and the ensuing specification, the invention also contemplates associated embodiments.

### BRIEF DESCRIPTION OF THE DRAWINGS

Referring to the drawings:

FIG. 1 is a perspective view of a ceiling fan supported by a hanger assembly constructed and arranged in accordance with the principle of the invention;

FIG. 2 is an enlarged perspective view of the hanger assembly of FIG. 1;

FIG. 3 is a side elevational view of the hanger assembly of FIG. 1;

FIG. 4 is a perspective view of a brace of the hanger assembly of FIG. 1;

FIG. 5 is a perspective view of another brace of the hanger assembly of FIG. 1;

FIG. 6 is a perspective view of the braces of FIGS. 4 and 5 shown as they would appear engaged to one another;

FIG. 7 is a sectional view taken along line 7-7 of FIG. 2;

FIG. 8 is an exploded perspective view a hanger bracket and the junction box of the hanger assembly of FIG. 1 with portions of the hanger assembly between the hanger bracket and the junction box depicted in phantom outline for illustrative purposes;

FIG. 9 is a fragmented bottom elevational view of the hanger assembly of FIG. 1;

FIG. 10 is a side elevational view of another embodiment of a hanger assembly constructed and arranged in accordance with the principle of the invention;

FIG. 11 is a side elevational view of yet another embodiment of a hanger assembly constructed and arranged in accordance with the principle of the invention;

FIG. 12 is a side elevational view of a yet still another embodiment of a hanger assembly constructed and arranged in accordance with the principle of the invention;

FIG. 13 is a side elevational view of a further embodiment of a hanger assembly constructed and arranged in accordance with the principle of the invention;

FIG. 14 is a sectional view taken along line 14-14 of FIG. 13;

FIG. 15 is an exploded, fragmented perspective view of a joist bracket and a brace of the hanger assembly of FIG. 13;

FIG. 16 is a sectional view taken along line 16-16 of FIG. 15;

FIG. 17 is a view very similar to the view of FIG. 15 with the joist bracket mounted to a joist;

FIG. 18 is a perspective view of another embodiment of a joist bracket shown as it would appear in an extended configuration;

FIG. 19 is a view of the joist bracket of FIG. 18 shown as it would appear in a retracted configuration;

FIG. 20 is a perspective view of a joist attachment fixture of the joist bracket of FIG. 18;

FIG. 21 is a perspective view of two joist brackets mounted to a joist, in which each of the two joist brackets is constructed and arranged in accordance with the joist bracket shown in FIG. 18 with one disposed in an extended configuration and the other disposed in a retracted configuration;

FIG. 22 is a perspective view of a further embodiment of a joist bracket constructed and arranged in accordance with the principle of the invention;

FIG. 23 is a sectional view taken along line 23-23 of FIG. 22;

FIG. 24 is side elevational view of the joist bracket of FIG. 22 shown as it would appear in an extended configuration;

FIG. 25 is a side elevational view of the joist bracket of FIG. 22 shown as it would appear in a retracted configuration;

FIG. 26 is an exploded perspective view of yet a further embodiment of a joist bracket constructed and arranged in accordance with the principle of the invention;

FIG. 27 is a left side elevational view of a hanger assembly incorporating joist brackets each constructed and arranged in accordance with the principle of the invention;

FIG. 28 is a perspective view of one of the joist brackets of FIG. 27;

FIG. 29 is right side elevational view of the hanger assembly of FIG. 27; and

FIG. 30 is a perspective view of a joist attachment fixture for use with the joist bracket of FIG. 28.

### DETAILED DESCRIPTION OF PREFERRED EMBODIMENTS

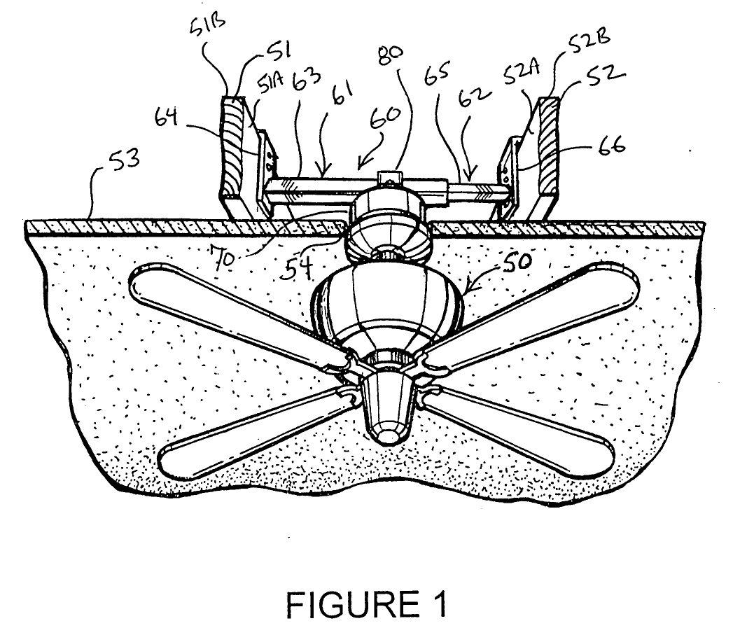

Turning now to the drawings, in which like reference characters indicate corresponding elements throughout the several views, attention is first directed to FIG. 1 in which there is seen a perspective view of a ceiling fan 50 supported by a hanger assembly 60 constructed and arranged in accordance with the principle of the invention. Hanger assembly 60 is installed between parallel horizontal joists 51 and 52, the latter being broken away in the drawing in the vicinity of hanger assembly 60 for purposes of illustration. Ceiling 53 is supported by the lower sides of joists 51 and 52, and is penetrated by junction box opening 54 affording access from the room below. Hanger assembly 60, like all the hanger assemblies disclosed in this specification, is exemplary of an inter-joist hanger assembly. Furthermore, although hanger assembly 60 is shown as would appear supporting a ceiling fan in FIG. 1, it may be used to support other loads, such as heavy lights, chandeliers, etc.

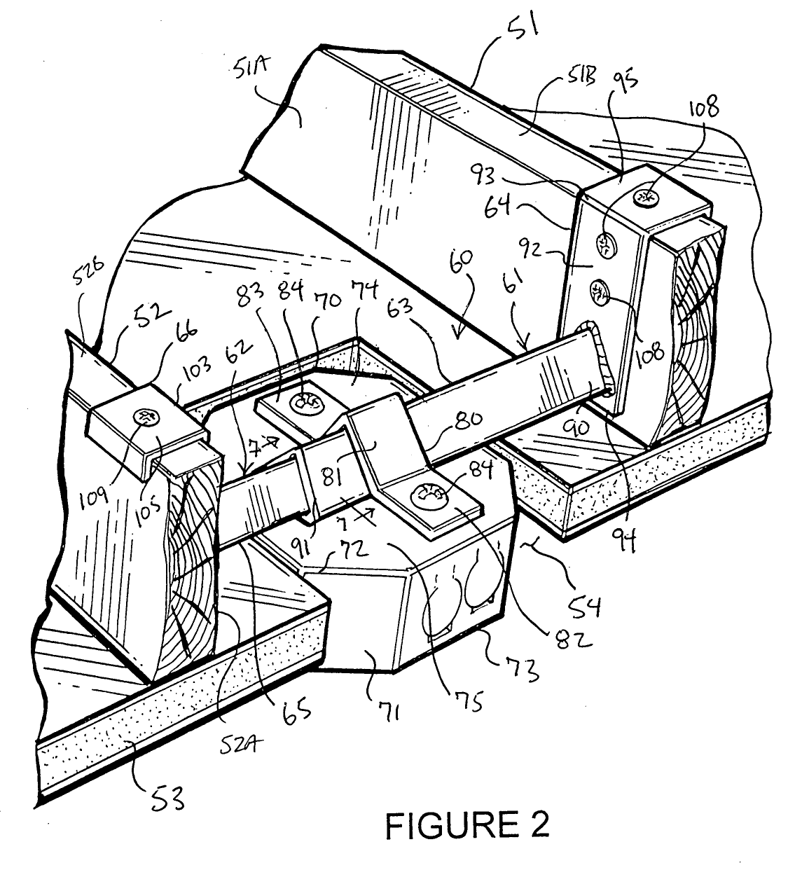

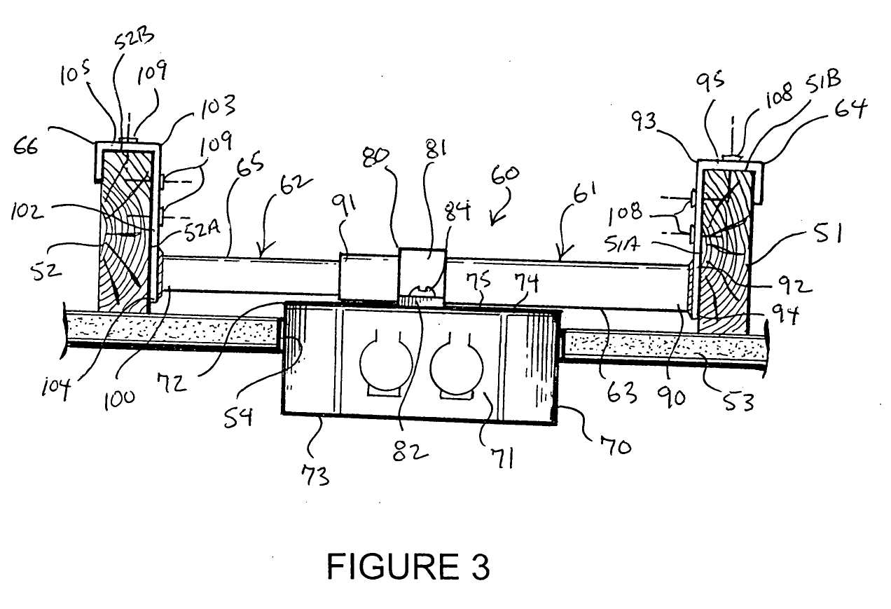

Referring also to FIGS. 2 and 3, hanger assembly 60 includes first and second braces 61 and 62, and a hanger bracket 80. Brace 61 consists of an elongate tubular member 63 rigidly attached to joist bracket 64, and brace 62 consists of an elongate insert 65 rigidly attached to joist bracket 66. According to the principle of the invention, insert 65 is partially received into and through tubular member 63, joist bracket 64 is secured to joist 52, joist bracket 66 is attached to joist 51, and tubular member 63 and insert 65 extend between joists 51 and 52 overlying opening 54.

A junction box 70 is supported by hanger assembly 60, which an annular sidewall 71 bounding an internally open cavity extending between a top end 72 of sidewall 71 and a bottom end 73 of sidewall 71. Bottom end 73 represents the underside or bottom side of box 70, and top end 72 represents to the topside of box 70. A top wall 74 overlies top end 72 of sidewall 71 and is integrally joined to top end 72. Top wall 74 has an upper/outer surface 75 and an opposing lower/inner surface facing into its internally open cavity. An elongate hanger bracket 80 has a central portion 81 overlying tubular member 63 and opposing ends 82 and 83 (end 83 not shown in FIG. 3) positioned against outer surface 75 of top wall 74, the former being attached to the latter with mechanical fasteners 84, which in this instance are nut-and-bolt assemblies but can be screws, pins, rivets, or the like.

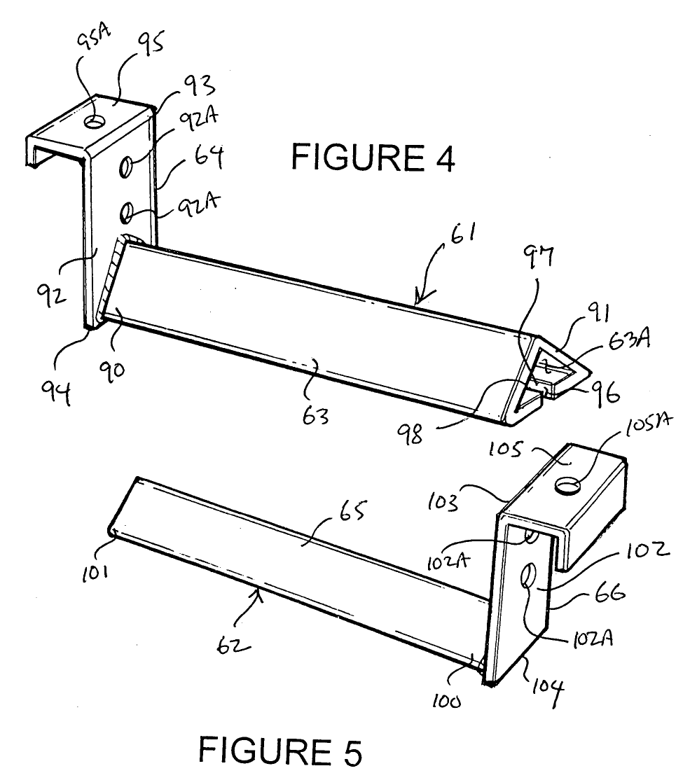

Further details of braces 61 and 62 will now be discussed in conjunction with FIGS. 4 and 5, respectively. Considering brace 61 in FIG. 4, tubular member 63 has opposing ends 90 and 91, in which end 90 is considered its proximal end and end 91 is considered its distal end. Joist bracket 64 consists of an upright member 92 formed with fastener openings 92A and having opposing upper and lower ends 93 and 94. End 90 of tubular member 63 is rigidly affixed to upright member 92 adjacent to lower end 94. A hook 95 formed with a fastener opening 95A is formed laterally outward of upper end 93. Tubular member 63 is hollow from end 90 to end 91, has a length extending from end 91 to end 90, and in this embodiment has a triangular vertical cross-sectional shape defining a triangular socket 63A extending therethrough from end 91 to end 90. Tubular member 63 is severed along its length from end 91 to end 90 forming an end gap 96 therein between opposing edges 97 and 98 thereof. In this embodiment, end gap 96 is formed on the underside of tubular member 63.

Considering brace 62 in FIG. 4, insert 65 has opposing ends 100 and 101, in which end 100 is considered its proximal end and end 101 is considered its distal end. Joist bracket 66 is identical to joist bracket 64 consisting of an upright member 102 formed with fastener openings 102A and having opposing upper and lower ends 103 and 104. End 100 of insert 65 is rigidly affixed to upright member 102 adjacent to lower end 104. A hook 105 formed with a fastener opening 105A is formed laterally outward of upper end 103. Insert 65 is hollow from end 100 to end 101 although it need not be. Insert 65 has a generally vertical cross-sectional shape that conforms substantially to the vertical cross-sectional shape of socket 63A, and has a length extending from end 100 to end 101. Tubular member 63 and insert 65 are substantially equal in length.

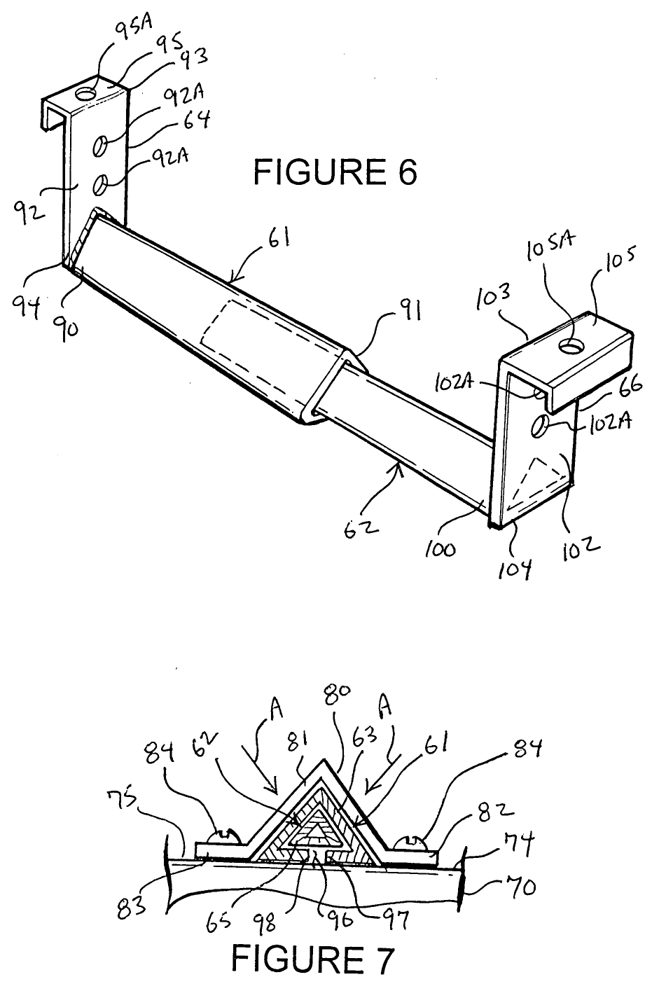

Insert 65 is somewhat smaller than socket 63A, and is partially received end 101 first into and through socket 63A through end 91 as seen in FIG. 6, in which joist brackets 64 and 66 each project upwardly at either end of hanger assembly 60 and end gap 96 projects downwardly on the underside of tubular member 63. The complementing triangular shapes between socket 63A and insert 65 prevent braces 61 and 62 from rotating relative to each other, and insert 65 is yet capable of reciprocal movement in socket 63A relative to tubular member 63 allowing the length of hanger assembly 60 from joist bracket 64 to joist bracket 66 to be adjusted as needed, in accordance with the principle of the invention.

Braces 61 and 62 are positioned between joists 51 and 52 on the underside of ceiling 53 as shown in FIGS. 1-3, and its overall length therebetween is adjusted by reciprocating braces 61 and 62 relative to one another in order to position joist brackets 64 and 66 on joists 51 and 52, respectively, on either side of opening 54. Upright members 92 and 102 are substantially parallel relative to each other and are positioned against the inner faces 51A and 52A of joists 51 and 52, respectively, and hooks 95 and 105 are hooked over top edges 51B and 52B of joists 51 and 52, respectively. Joist bracket 64 is then fastened to joist 51 with screws 108 extending into joist 51 through fastener openings 92A and 95A, and joist bracket 66 is fastened to joist 52 with screws 109 extending into joist 52 through fastener openings 102A and 105A. Although it hardly seems worth mentioning, those having regard for the art will readily appreciate that joist brackets 64 and 66, like all of the joist brackets disclosed in this specification, can incorporate any desired number of fastener openings.

As seen in FIGS. 2 and 3, braces 61 and 62 are mounted to joists 51 and 52 positioning tubular member 63 atop opening 54 on the underside of ceiling 53. Opening 54 is formed through ceiling 54 between joists 51 and 52 and is positioned such that when braces 61 and 62 are mounted in place tubular member 63 including a portion of insert 65 extending therethrough overlies opening 54, in which end gap 96 on the underside of tubular member 63 faces opening 54.

Junction box 70 is positioned at opening 54 and outer surface 75 of its top wall 74 is directed against the underside of tubular member 63. Hanger bracket 80 is positioned atop tubular member 63 traversing it opposite upper surface 75 of top wall 74 at a point where tubular member 63 and insert 65 overlap. Central portion 81 sits across tubular member 63 and its ends 82 and 83 are positioned against outer surface 75 of top wall 74 on either side of tubular member 63 and are fastened to top wall 74 with fasteners 84, and this described arrangement is also clearly shown in FIG. 7, which is a sectional view taken along line 7-7 of FIG. 2.

Central portion 81 is formed to substantially conform to the shape of the outer surface of tubular member 63 as best seen in FIG. 7, and is somewhat smaller relative to tubular member 63. As a result, when ends 82 and 83 are fastened to top wall 74, central portion 81 is forcibly exerted against tubular member 63 and, in accordance with the principle of the invention, exerts a compressive force against tubular member 63 in the directions indicated by the arrowed lines A in FIG. 7 partially collapsing tubular member 63 at least partially closing end gap 96 causing tubular member 63 to constrict about insert 65 thereby grippingly and frictionally securing insert 65 extending therethrough securing hanger assembly 60 at a fixed length. The spacing between central portion 81 of hanger bracket 80 and tubular member 63 and between tubular member 63 and insert 65 is exaggerated in FIG. 7 for illustrative purposes only.

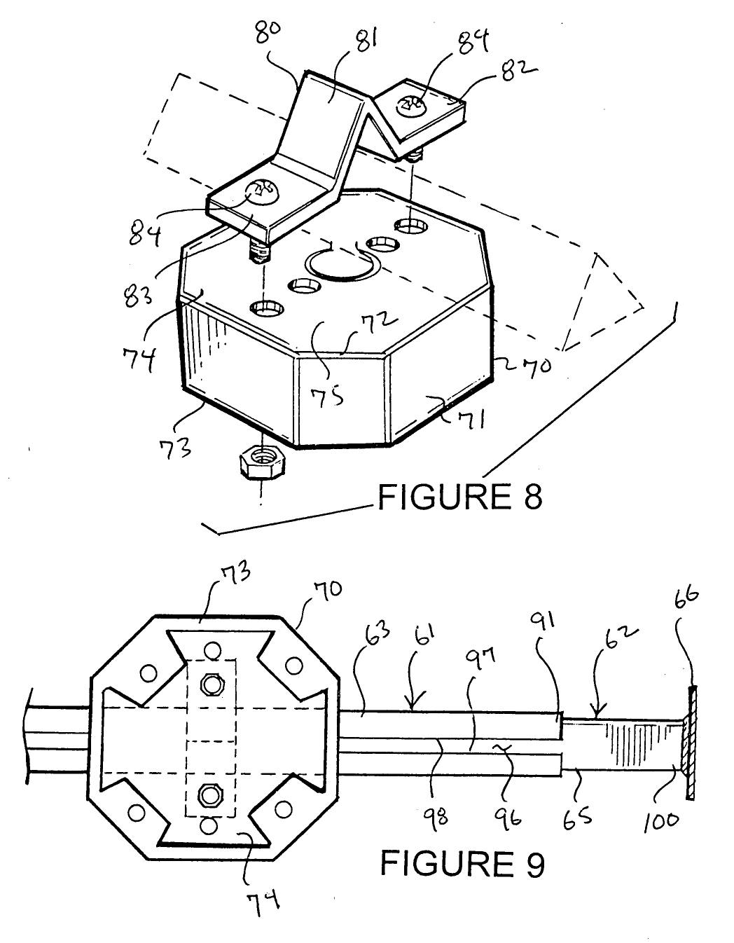

As a matter of illustration, FIG. 8 is an exploded perspective view of hanger bracket 80 as it would appear positioned opposite upper surface 75 of top wall 74 of junction box 70, with a length of tubular member 63 depicted in phantom outline positioned therebetween. Furthermore, FIG. 9 is a fragmented bottom elevational view of junction box 70 shown as it would appear attached to tubular member 63 and showing end gap 96 extending along the underside of tubular member 63.

The completed installation of hanger assembly 60 is shown in FIGS. 2 and 3, in which junction box 70 is positioned at opening 54 and is there fixed in place to tubular member 63 with hanger bracket 80. When junction box 70 is fastened to tubular member 63 with hanger bracket 80, it is to be understood that junction box 70 and hanger bracket 80 are considered part of hanger assembly 60. In the preferred installation shown in FIG. 3, bottom end 73 of junction box 70 is positioned outboard of, or otherwise below, the outer surface or outer face of ceiling 53 and is available to secure a load, such as ceiling fan 50 shown in FIG. 1, in which the load is primarily born at hooks 95 and 105 against top sides/edges 51B and 52B of joists 51 and 52 providing exemplary load support. Ceiling fan 50 can be mounted directly to junction box 70 as shown in FIG. 1, or to the end of a downrod mounted to a downrod bracket affixed to junction box 70.

In the preferred embodiment of hanger assembly 60, tubular member 63 and insert 65 have complementing triangular shapes. This is disclosed as a matter of example, with the understanding that other complementing shapes may be used commensurate with the teachings of this disclosure without departing from the invention including, for instance, complementing square shapes, rectangular shapes, octoganal shapes, etc.

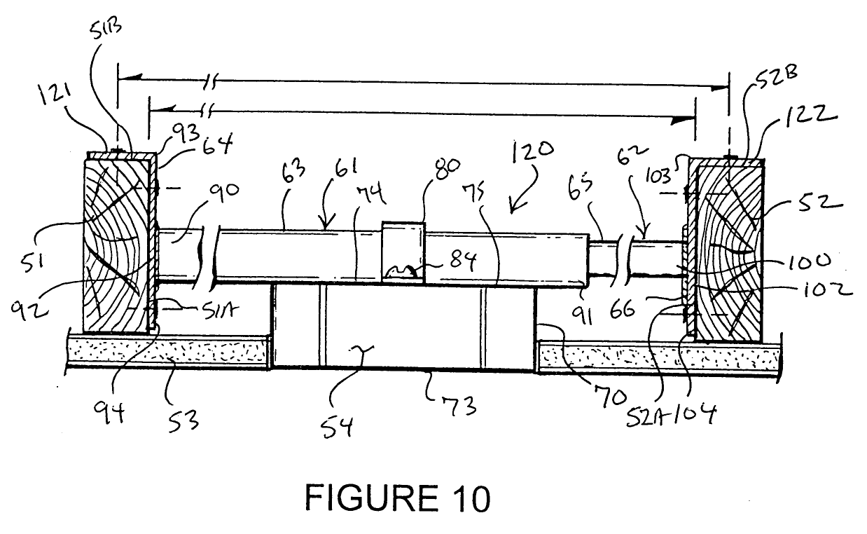

Reference is now made to FIG. 10, in which there is seen another embodiment of a hanger assembly 120 constructed and arranged in accordance with the principle of the invention. In common with hanger assembly 60, hanger assembly 120 shares brace 61 including joist bracket 64 attached to joist 51, brace 62 including joist bracket 66 attached to joist 52, hanger bracket 80, and junction box 70 disposed at opening 54 through ceiling 53. Unlike hanger assembly 60, end 90 of tubular member 63 of brace 61 is rigidly affixed to upright member 92 at an intermediate location between upper and lower ends 93 and 94 thereof, and end 100 of insert 65 of brace 62 is rigidly affixed to upright member 102 at an intermediate location between upper and lower ends 103 and 104 thereof, such that bottom end 73 of junction box 70 mounted to tubular member 63 with hanger bracket 80 is positioned flush with the outer face or outer side of ceiling 53. Also, joist brackets 64 and 66 in connection with hanger assembly 120 rather than having hooks formed laterally outward of upper ends 93 and 103, respectively, have horizontal plates 121 and 122 formed laterally outward of upper ends 93 and 103 of joist brackets 64 and 66, respectively. Joist brackets 64 and 66 in connection with hanger assembly 120 are fastened to joists 51 and 52 with screws as with hanger assembly 60. Like hooks 95 and 105 discussed on conjunction with hanger assembly 60, plates 121 and 122 are positioned atop top edges 51B and 52B of joists 51 and 52, respectively.

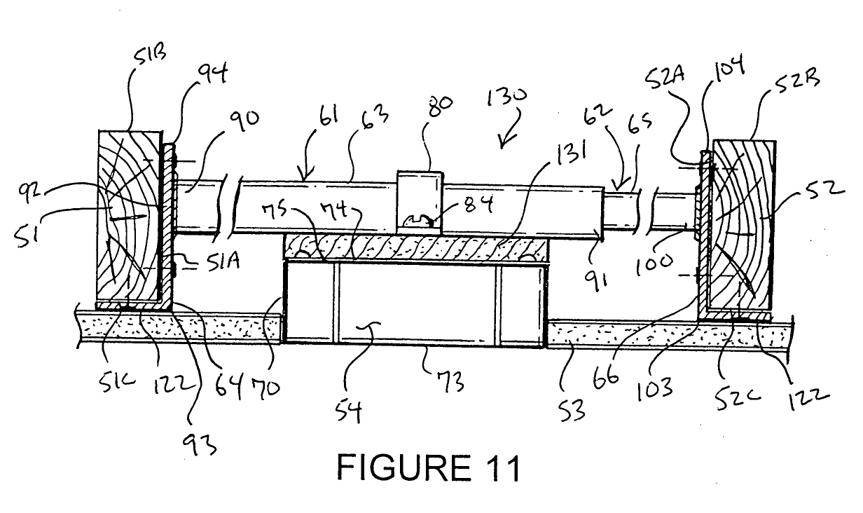

FIG. 11 is a side elevational view of yet another embodiment of a hanger assembly 130 constructed and arranged in accordance with the principle of the invention. In common with hanger assembly 120, hanger assembly 120 shares brace 61 including joist bracket 64 with plate 121 attached to joist 51, brace 62 including joist bracket 66 with plate 122 attached to joist 52, hanger bracket 80, and junction box 70 disposed at opening 54 through ceiling 53. Unlike hanger assembly 60, joist brackets 64 and 66 are inverted, and plates 121 and 122 are positioned between the underside of ceiling 53 and lower sides/edges 51C and 52C of joists 51 and 52, respectively. Also, a spacer 131 is positioned between tubular member 63 and upper surface 75 of top wall 74 in this embodiment. Spacer 131 is positioned against outer surface 75 of top wall 74 and overlies outer surface 75 of top wall 74, and provides a selected spacing between tubular member 63 and upper surface 75 of top wall 74 for selectively positioning bottom end 73 of junction box 70 at a specific location, which in this embodiment is flush with the outer face or outer side of ceiling 53. A spacer between a junction box and a brace of a hanger assembly constructed and arranged in accordance with the principle of the invention may be used with any of the hanger assemblies herein disclosed for providing desired spacing of the junction box from a brace of the hanger assembly for positioning the lower end of the junction box at a desired location relative to the ceiling.

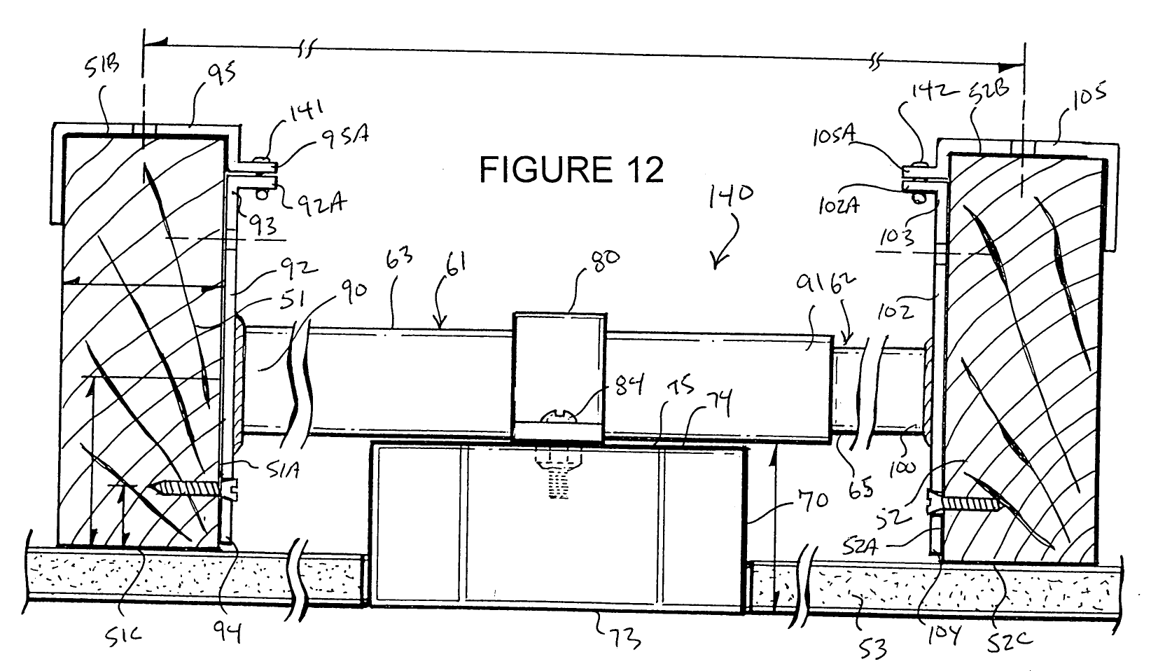

Reference is now made to FIG. 12, in which there is seen a side elevational view of still another embodiment of a hanger assembly 140 constructed and arranged in accordance with the principle of the invention. In common with hanger assembly 60, hanger assembly 140 shares brace 61 including joist bracket 64 attached to joist 51, brace 62 including joist bracket 66 attached to joist 52, hanger bracket 80, and junction box 70 disposed at opening 54 through ceiling 53. Joist brackets 64 and 66 are each provided as two attached parts, which are adjustable between extended and retracted configurations for allowing hanger assembly 140 to be mounted to joists of different sizes and for adjusting the hanger assembly to position a junction box attached thereto at a selected location relative to a ceiling.

Considering joist bracket 64, upright member 92 is the first part hook 95 is the second part. Upper end 93 of upright member 92 and hook 95 of joist bracket 64 are formed with flanges 92A and 95A, respectively, that project laterally outward and which are fastened together with a mechanical fastener, which in this instance is a pin 141 but which may be a rivet, screw, or the like, and even two or more of the foregoing. And so although one mechanical fastener is shown securing flanges 92A and 95A together, more may be used if desired. Similarly, upper end 103 of upright member 102 and hook 105 of joist bracket 66 are formed with flanges 102A and 105A that project laterally outward and which are fastened together with a mechanical fastener, which in this instance is a pin 121 but which may be a rivet, screw, or the like, and even two or more of the foregoing. And so although one mechanical fastener is shown securing flanges 102A and 105A together, more may be used if desired. Like hanger assembly 60, joist brackets 64 and 65 of hanger assembly 140 are fastened to joists 51 and 52 with screws, and the provision of having two-piece joist brackets 64 and 65 allow the hooks to be replaced if they become damaged, in accordance with the principle of the invention. Like hanger assembly 120, end 90 of tubular member 63 of brace 61 of hanger assembly 140 is rigidly affixed to upright member 92 at an intermediate location between upper and lower ends 93 and 94 thereof, and end 100 of insert 65 of brace 62 of hanger assembly 140 is rigidly affixed to upright member 102 at an intermediate location between upper and lower ends 103 and 104 thereof, such that bottom end 73 of junction box 70 mounted to tubular member 63 with hanger bracket 80 is positioned flush with the outer face or outer side of ceiling 53.

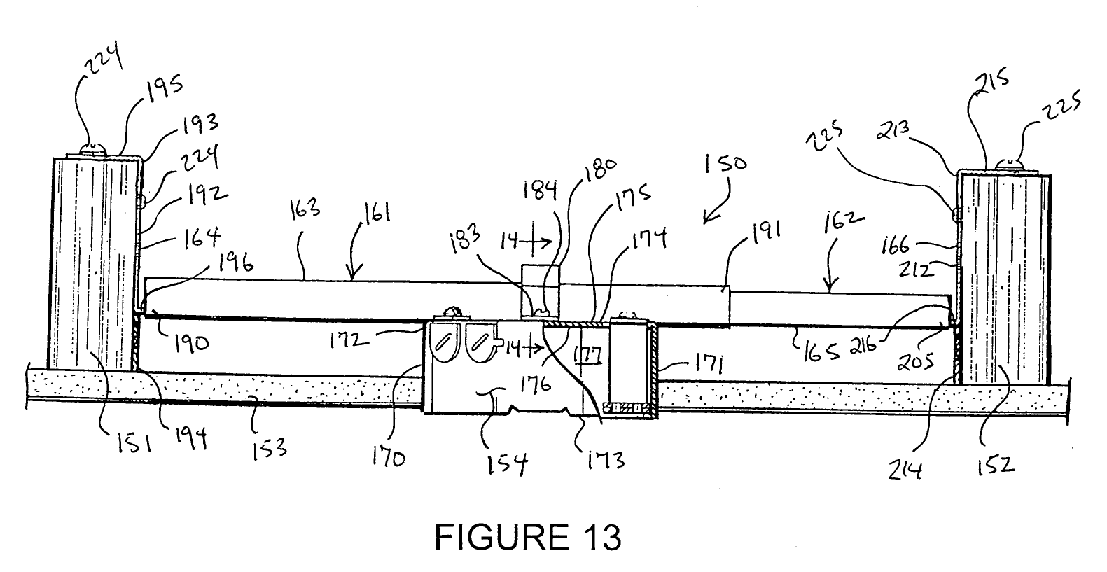

Attention is now directed to FIG. 13, in which there seen yet still another embodiment of a hanger assembly 150 constructed and arranged in accordance with the principle of the invention. Hanger assembly 150 is installed between parallel horizontal joists 151 and 152, the latter being in vertical cross section in the drawing in the vicinity of hanger assembly 150 for purposes of illustration. Ceiling 153 is supported by the lower sides of joists 151 and 152, and is penetrated by junction box opening 154 affording access from the room below.

Hanger assembly 150 includes first and second joined braces 161 and 162, and a hanger bracket 180 being exemplary of the principle of the invention. Brace 161 consists of an elongate tubular member 163 removably attached to joist bracket 164, and brace 162 consists of an elongate insert 165 removably attached to joist bracket 166. Insert 165 is partially received into and through tubular member 163, joist bracket 164 is secured to joist 152, joist bracket 166 is attached to joist 151, and tubular member 163 and insert 165 extend between joists 151 and 152 overlying opening 154.

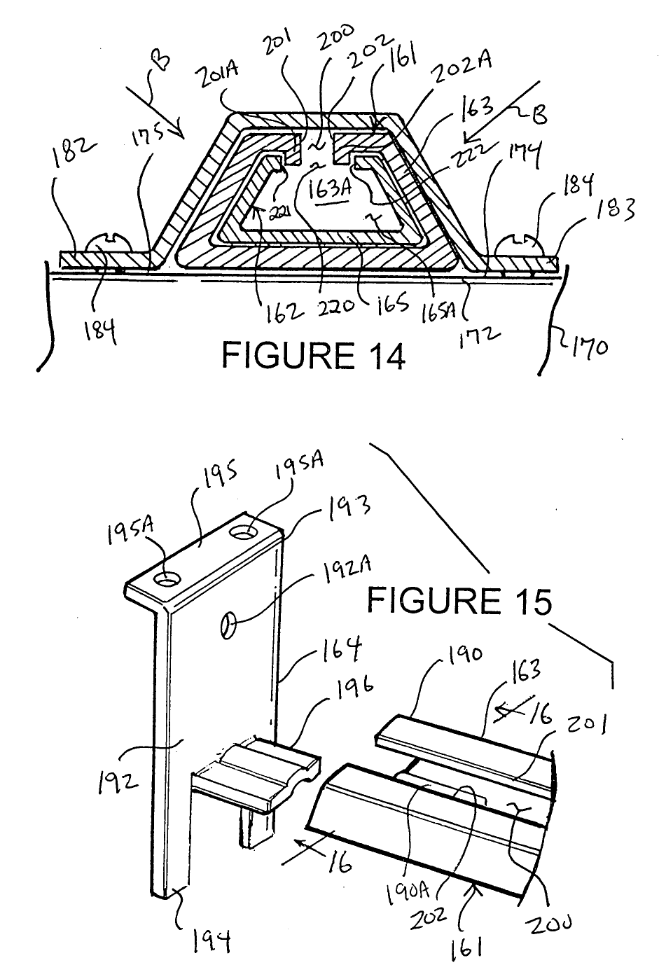

Junction box 170 is supported by hanger assembly 160, which, like junction box 70 previously discussed, includes an annular sidewall 171 bounding an internally open cavity extending between a top end 172 of sidewall 171 and a bottom end 173 of sidewall 171. Bottom end 173 represents the underside of box 170 and top end 172 represents the upper end of box 170. A top wall 174 overlies top end 172 of sidewall 171 and is integrally joined to top end 172. Top wall 174 has an upper/outer surface 175 and an opposing lower/inner surface 176 facing into its internally open cavity 177. An elongate hanger bracket 180 has a central portion 181 overlying tubular member 163 and, as seen in FIG. 14, opposing ends 182 and 183 (end 83 not shown in FIG. 13) positioned against outer surface 175 of top wall 174, the former being attached to the latter with mechanical fasteners 184, which in this instance are nut-and-bolt assemblies but can be screws, pins, rivets, or the like or whatever is suitable.

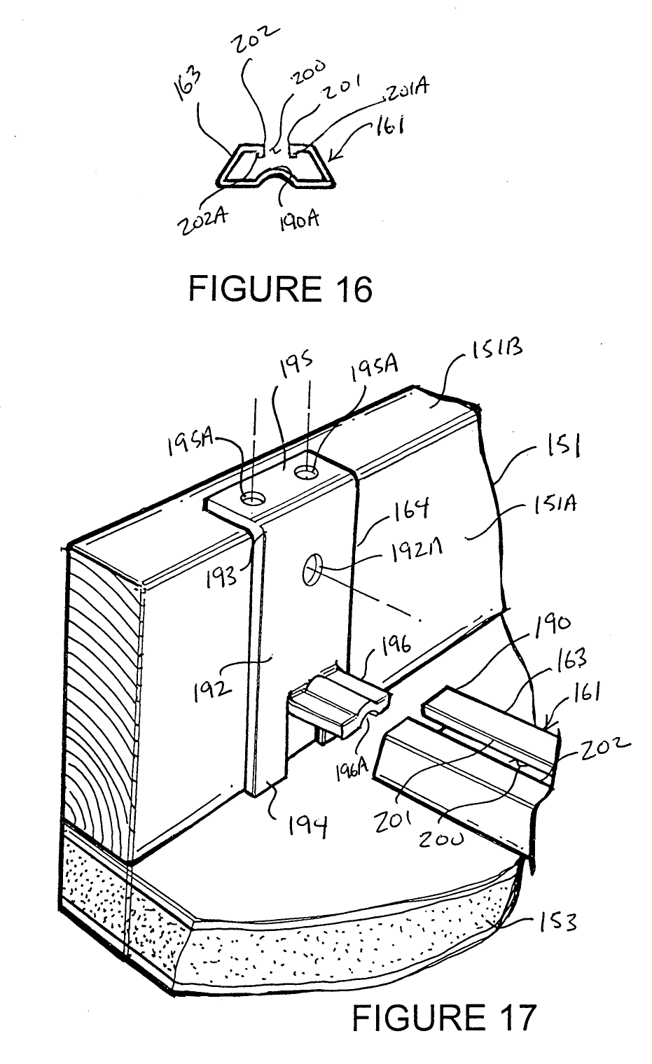

Tubular member 163 has opposing ends 190 and 191, in which end 190 is considered its proximal end and end 191 is considered its distal end. Joist bracket 164, which is also shown in FIGS. 15 and 16, consists of an upright member 192 formed with a fastener opening 192A and having opposing upper and lower ends 193 and 194. A plate 195 formed with fastener openings 195A is formed laterally outward of upper end 193. A key 196 is formed laterally inward of upright member 192 between upper and lower ends 193 and 194.

Tubular member 163 is hollow from end 190 to end 191, has a length extending from end 191 to end 190 and has vertical cross-sectional shape which is substantially exemplary of an isosceles trapezoid as shown in FIG. 14 defining an isosceles trapezoid-shaped socket 163A extending therethrough from end 191 to end 190 (ends 190 and 191 not shown in FIG. 14). Tubular member 163 is severed along its length from end 191 to end 190 forming an end gap 200 therein between opposing edges 201 and 202 thereof. In this embodiment, end gap 200 is formed on upper side of tubular member 163. Edges 201 and 202 are formed with inwardly directed stops 201A and 202A.

Insert 165 has opposing ends, including end 205 (FIG. 13), which is considered the proximal end of insert 165, and an opposing end (not shown), which is considered the distal end of insert 165. Joist bracket 166 is identical to joist bracket 164 consisting of, as seen in FIG. 13, an upright member 212 formed with a fastener opening (not shown) and having opposing upper and lower ends 213 and 214. A plate 215 formed with fastener openings (not shown) is formed laterally outward of upper end 213. A key 216 is formed laterally inward of upright member 212 between upper and lower ends 213 and 214.

Insert 165 is hollow from its proximal end 205 to its distal end and is thus a tubular member. Insert 165 has a length extending from its proximal end 205 to its distal end and has vertical cross-sectional shape that conforms substantially to the vertical cross-sectional shape of socket 163A, which in this instance as seen in FIG. 14 is that of an isosceles trapezoid defining an isosceles trapezoid-shaped socket 165A extending therethrough from its proximal end 205 to its distal end (proximal and distal ends of insert 165 not shown in FIG. 14). Insert 165 is severed along its length from its proximal end 205 to its distal end forming an end gap 220 therein between opposing edges 221 and 222 thereof. In this embodiment, end gap 220 is formed on upper side of insert 165. Tubular member 163 and insert 165 are substantially equal in length.

Insert 165 is somewhat smaller than socket 163A, and is partially received distal end first into and through socket 163A through end 191 as seen in FIG. 13, in which joist brackets 164 and 166 each project upwardly at either end of hanger assembly 160 and end gaps 196 and 220 are concurrent and project upwardly. The complementing isosceles trapezoidal shapes between socket 163A and insert 165 prevent braces 161 and 162 from rotating relative to each other, and insert 165 is yet capable of reciprocal movement in socket 163A relative to tubular member 163 allowing the length of hanger assembly 160 from joist bracket 164 to joist bracket 166 to be adjusted as needed.

Braces 161 and 162 are positioned between joists 151 and 152 on the underside of ceiling 153 as shown in FIG. 13. End 190 of tubular member 163 is open forming a keyhole, as is end 205 of insert 165 forming its own keyhole. Ends 190 and 205 are engaged to joist brackets 164 and 166 by inserting keys 196 and 216 into the keyholes at ends 190 and 205, respectively. Keys 196 and 216 and open ends 190 and 205, respectively, have complementing shapes providing a keyed/mating engagement therebetween.

As seen in FIGS. 15 and 17, key 196 fits into end 190 and is formed with a recess 190A which keys onto a protuberance 190A formed in end 190 of tubular member 163 as shown in FIG. 16, which is a sectional view taken along line 16-16 of FIG. 15. The discussion of the keyed engagement of key 196 to end 190 of tubular member 163 also applies to key 216 and end 205 of insert 165, and the foregoing discussion of the keyed engagement of end 190 of tubular member 163 to joist bracket 164 applies to the keyed engagement of end 205 of insert 165 to joist bracket 166. The keyed attachment of ends 190 and 205 to joist brackets 164 and 166 provides for the easy assembly and disassembly of hanger assembly 160. It is to be understood that although joist brackets 164 and 166 support keys and tubular member 163 and insert 165 support complementing keyholes, this arrangement may be reversed, if desired, in which case joist brackets 164 and 166 may be formed with keyholes and tubular member 163 and insert 165 may be formed with keys. Any complementing keyed shapes may be used providing the keyed engagement of tubular member 163 and insert 165 to joist brackets 164 and 166, respectively.

The length of hanger assembly 160 is adjusted by reciprocating braces 161 and 162 relative to one another in order to position joist brackets 164 and 166 on joists 151 and 152, respectively, on either side of opening 154. Upright members 192 and 212 are substantially parallel relative to each other and are positioned against inner faces 151A and 152A of joists 51 and 52, respectively, and plates 195 and 215 are positioned atop top edges 151B and 152B of joists 51 and 52, respectively. Joist bracket 164 is fastened to joist 151 with screws 224 extending into joist 151 through its fastener openings 192A and 195A, and joist bracket 166 is fastened to joist 152 with screws 225 extending into joist 152 through its fastener openings. Braces 161 and 162 are mounted to joists 151 and 152 positioning tubular member 163 atop opening 154 on the underside of ceiling 153. Opening 154 is formed through ceiling 154 between joists 151 and 152 and is positioned such that when braces 161 and 162 are mounted in place tubular member 163 including a portion of insert 165 extending therethrough overlies opening 154, in which end gaps 196 and 220 (FIG. 14) on the upper sides of tubular member 163 and insert 165 face upwardly away from opening 154.

Junction box 170 is positioned at opening 154 and outer surface 175 of its top wall 174 is directed against the underside of tubular member 163. Hanger bracket 180 is positioned atop tubular member 163 opposite upper surface 175 of top wall 174 at a point where tubular member 163 and insert 165 overlap, central portion 181 thereof being positioned atop and traversing tubular member 163 and ends 182 and 183 thereof being positioned against outer surface 175 of top wall 174 on either side of tubular member 163 and fastened to top wall 174 with fasteners 184, and this described arrangement is clearly shown in FIG. 14.

Hanger bracket 180 is transverse relative to tubular member 163, and central portion 181 is formed to substantially conform to the outer surface of tubular member 163 as best seen in FIG. 14, and is yet somewhat smaller relative to tubular member 163 and when ends 182 and 183 are fastened to top wall 174 central portion 181 exerts a compressive force against tubular member 163 in the directions indicated by the arrowed lines B in FIG. 14 partially collapsing tubular member 163 and in turn partially collapsing insert 165 at least partially closing end gaps 200 and 220 and bringing 201A and 202A into forcible engagement against edges 221 and 222, respectively, and forcibly exerting inner surface 163B of tubular member 163 against outer surface 165B of insert 165 thereby grippingly and frictionally securing inner surface 163B of tubular member 163 to outer surface 165B of insert 165 securing hanger assembly 160 at a fixed length, in accordance with the principle of the invention. The spacing between central portion 181 of hanger bracket 180 and tubular member 163 and between tubular member 163 and insert 165 is exaggerated in FIG. 14 for illustrative purposes only.

The completed installation of hanger assembly 160 is thus shown in FIG. 13, in which junction box 170 is positioned at opening 154 and there fixed in place to tubular member 163 with hanger bracket 180. When junction box 170 is fastened to tubular member 163 with hanger bracket 180, it is to be understood that junction box 170 and hanger bracket 180 are considered part of hanger assembly 160. In the preferred installation shown in FIG. 3, bottom end 173 of junction box 170 is positioned outboard of, or otherwise below, the outer surface or outer face of ceiling 153 and is available to secure a load, such as a ceiling fan or a light fixture or other load, in which the load is primarily born at plates 195 and 215 against top sides/edges 151B and 152B of joists 151 and 152. A ceiling fan can be mounted directly to junction box 170 or to the end of a downrod mounted to a downrod bracket affixed to junction box 170. As seen in FIG. 13, joist brackets 164 and 166 constructed of lengths such that their lower ends 194 and 214 are presented against the underside of ceiling 153.

In the preferred embodiment of the hanger assembly designated 160, tubular member 163 and insert 165 have complementing isosceles trapezoidal shapes. This is disclosed as a matter of example, with the understanding that other complementing shapes may be used commensurate with the teachings of this disclosure without departing from the invention including, for instance, complementing square shapes, rectangular shapes, octoganal shapes, etc.

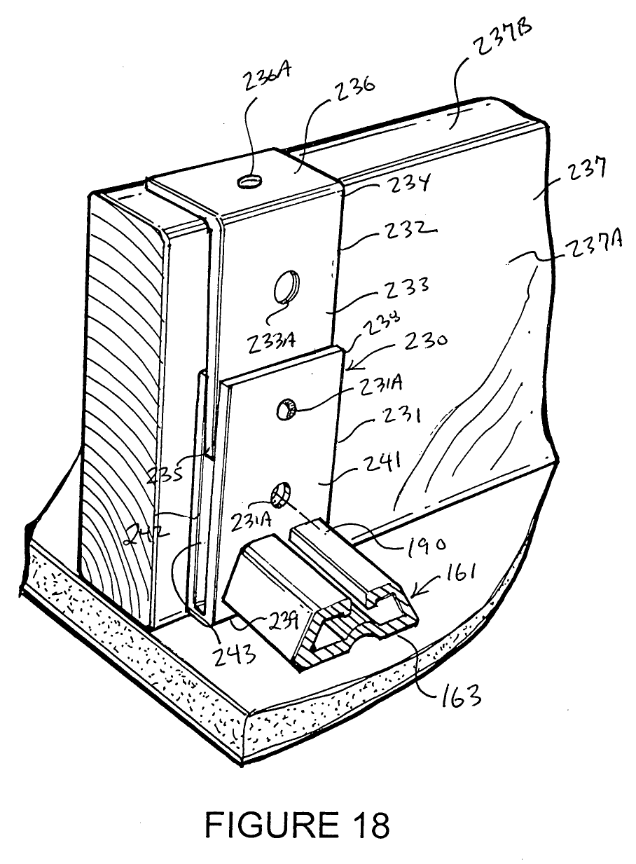

FIGS. 18-26 show alternate configurations of joist brackets that may be used with hanger assemblies constructed and arranged in accordance with the principle of the invention. Looking first to FIG. 18, a joist bracket 230 is shown which is discussed in conjunction with end 190 of tubular member 163 of hanger assembly 160 as a matter of example, with the understanding that joist bracket 230 may be employed in conjunction with any of the hanger assemblies disclosed herein and attached by way of a keyed engagement or a rigid attachment.

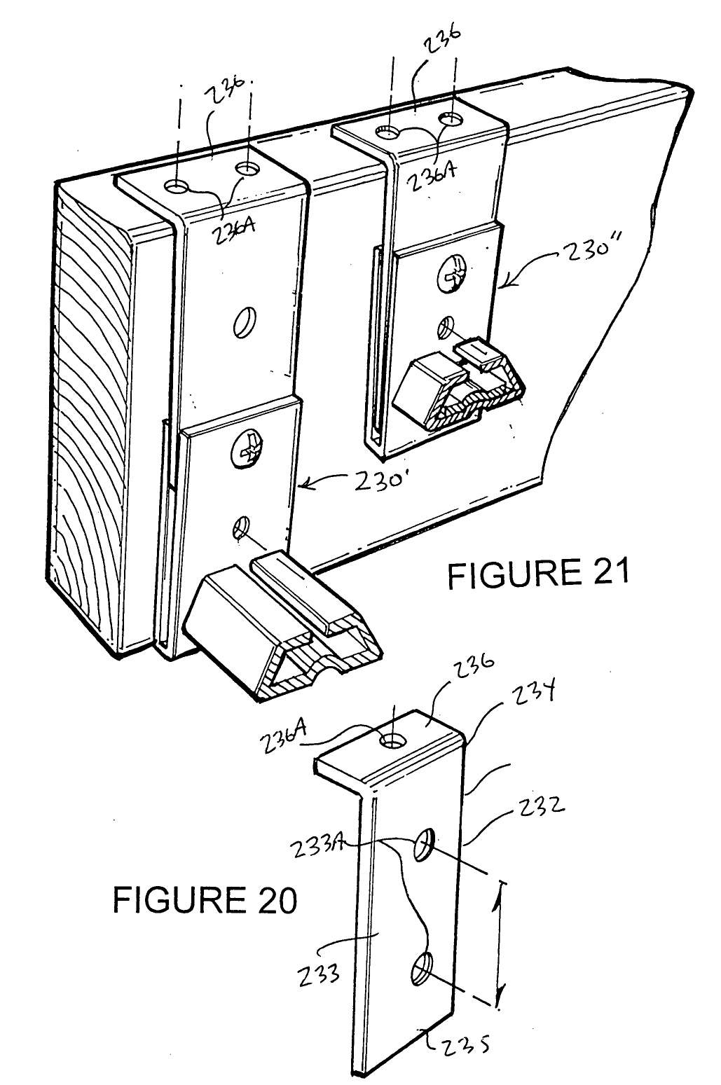

Joist bracket 230 consists of a coupling 231 attached to end 190 of tubular member 163, and a joist attachment fixture 232, which is engagable to coupling 231 in an extended position and also in a retracted position, which allows joist bracket 230 to be adjusted between extended and retracted configurations. Fixture 232 includes an upright member 233 having opposing upper and lower ends 234 and 235 and a plate 236 formed laterally outward of upper end 234. As shown in FIG. 20, there are fastener openings 233A formed through upright member 233 and a fastener opening 236A through plate 236, and through which screws may be passed for securing fixture 232 to a joist 237 shown in FIG. 18. Upright member 233 has two fastener openings 233A including an upper fastener opening 233A adjacent to upper end 234 and a lower fastener opening 233A adjacent to lower end 235.

Coupling 231 is a generally U-shaped member having opposing upstanding sidewalls 241 and 242 attached at lower ends thereof forming a socket 243 into which a lower end 234 of fixture 232 is received. Opposing pairs of fastener openings 231A are formed through sidewalls 241 and 242. Coupling 231 has pairs of fastener openings 231A through sidewalls 241 and 242, including an upper pair of fastener openings 231A adjacent to upper end 238 of coupling 231 and a lower pair of fastener openings 231A adjacent to lower end 239 of coupling 231.

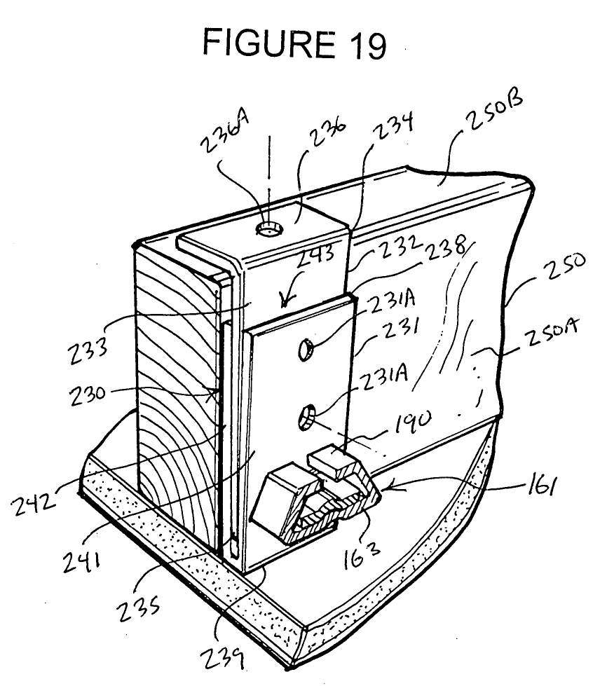

By first introducing lower end 235 of fixture 232 into socket 243 making upright member 233 partially received into and through socket 243, fixture 232 may be reciprocated in socket 243 relative to coupling 231 between an extended position thereof relative to coupling 231 as shown in FIG. 18 defining an extended configuration of joist bracket 230 and a retracted position thereof relative to coupling 231 as shown in FIG. 19 defining a retracted or shortened configuration of joist bracket 230. In the extended configuration of joist bracket 230, the upper pair of fastener openings 231A of coupling 231 is aligned with the lower fastener opening 233A of fixture 232. In the retracted configuration of joist bracket 230, the upper pair of fastener openings 231A of coupling 231 is aligned with the upper fastener opening 233A of fixture 232.

Joist 237 in FIG. 18 is representative of a 2×6 joist, and in the extended configuration as shown in FIG. 18 joist bracket 230 is appropriately sized to be fitted thereon. To fit joist bracket 230 to joist 237, coupling 231 and upright member 233 of fixture 232 are positioned against face 237A of joist 237 and plate 236 is positioned atop top side/edge 237B of joist 237. With joist bracket 230 disposed in its extended configuration, screws are passed into joist 237 through the fastener openings of joist bracket 230 to secure joist bracket 230 in place to joist 237 in its extended configuration. In its extended configuration the lower end 239 of coupling 231 of joist bracket 230 is positioned against the underside of the ceiling as shown in FIG. 18.

Joist 250 in FIG. 18 is representative of a 2×4 joist, and in the retracted configuration as shown in FIG. 19 joist bracket 230 is appropriately sized to be fitted thereon. To fit joist bracket 230 to joist 250, coupling 231 and upright member 233 of fixture 232 are positioned against face 250A of joist 250 and plate 236 is positioned atop top side/edge 250B of joist 250. With joist bracket 230 disposed in its retracted configuration, screws are passed into joist 237 through the fastener openings of joist bracket 230 to secure joist bracket 230 in place to joist 237 in its retracted configuration. In its retracted configuration the lower end 239 of coupling 231 of joist bracket 230 is positioned against the underside of the ceiling as seen in FIG. 19.

If desired, joist bracket 230 can be disposed at an intermediate length between its extended and retracted configurations by positioning the lower pair of fastener openings 231A of coupling 231 with the lower fastener opening 233A of fixture 232. It is to be understood that coupling 231 and fixture 232 may be fashioned with any desired number of fastener openings through plate 236 and also corresponding fastener opens through upright member 233 and coupling 231 that when selectively aligned may form not only the desired length of the extended and retracted configurations but also one or more intermediate lengths therebetween as may be required in order to accommodate different joist mounting environments or specific needs or wishes. As a matter of disclosure, FIG. 21 shows two joist brackets each constructed and arranged in accordance with joist bracket 230 in which one bears the reference character 230′ and the other bears the reference character 230″. Joist bracket 230′ is shown mounted disposed on a joist in its extended configuration, and joist bracket 230″ is shown mounted on the joist in its retracted configuration. As a matter of example, plates 236 of joist brackets 230′ and 230″ each have two fastener openings 236A therethrough.

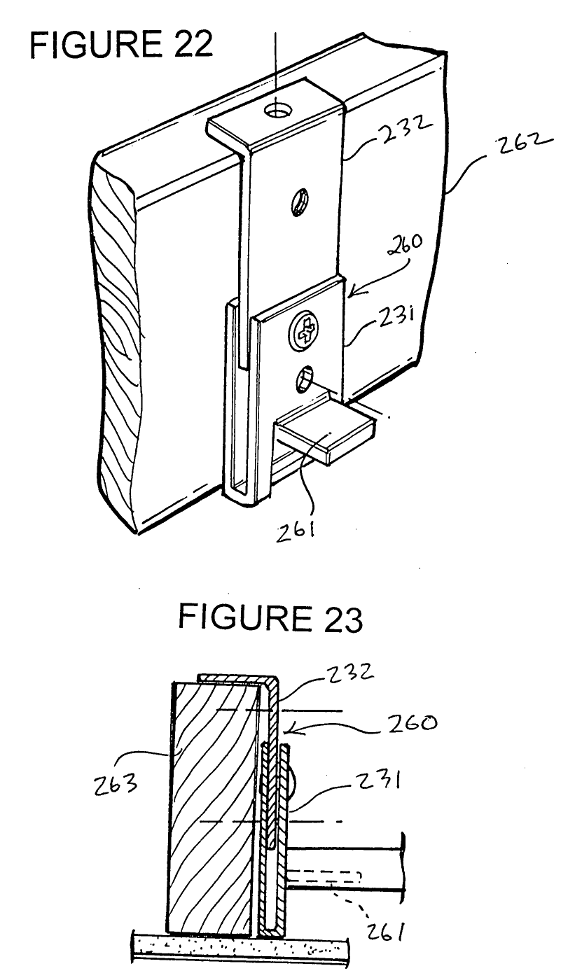

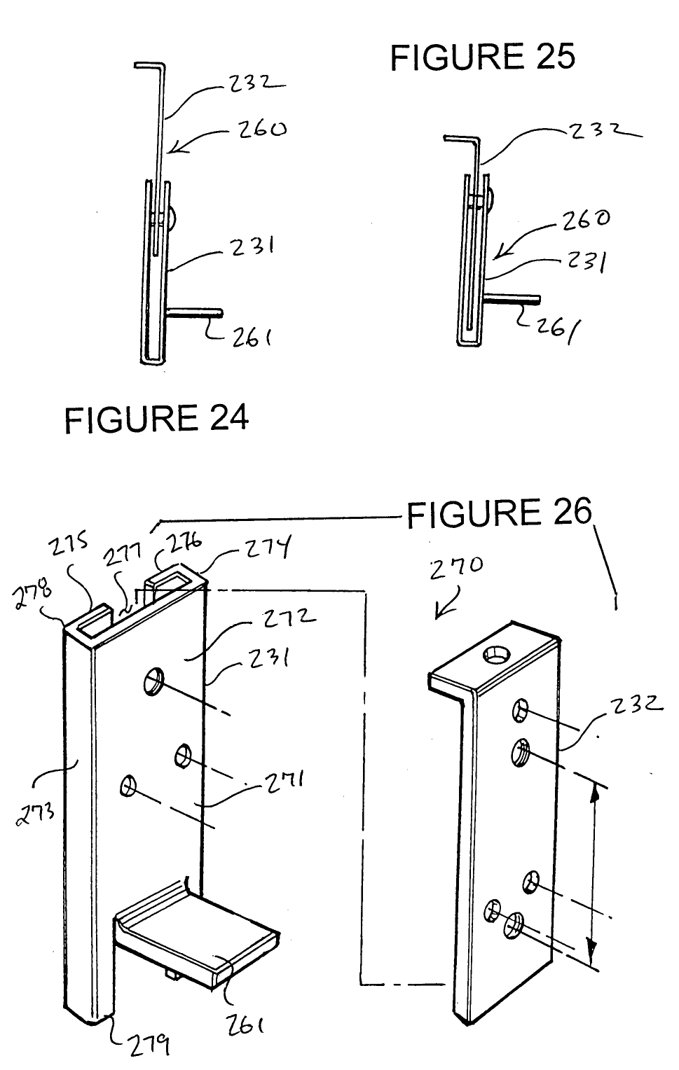

Referring now to FIGS. 22-25, yet another embodiment of a joist bracket 260 is shown. Joist bracket 260 is completely analogous to joist bracket 230 sharing coupling 231, fixture 232, and the various parts thereof previously discussed in conjunction with joist bracket 230. The instruction provided by joist bracket 260 is key 261, which is completely analogous to key 196 previously discussed in conjunction with hanger assembly 150 but yet has different shape, in which the end of a brace, such as the end of a tubular member or the end of an insert, is to be formed with a keyhole suitable to mate therewith. As a matter of disclosure and understanding, FIG. 22 shows joist bracket 260 as it would appear mounted to a 2×6 joist 262 in its extended configuration, FIG. 23 is a side elevational view of joist bracket 260 shown as it would appear mounted to a 2×4 joist 263 in its retracted configuration in which coupling 231 and fixture 232 are shown in vertical cross section and key 261 is shown in phantom outline disposed in the keyholed end of a tubular member, FIG. 24 is a side elevational view of joist bracket 260 as it would appear disposed in its extended configuration, and FIG. 25 is a side elevational view of joist bracket 260 as it would appear disposed in its retracted configuration.

Referring now to FIG. 26 there is seen an exploded perspective view of a further embodiment of a joist bracket 270. Joist bracket 270 is completely analogous to joist bracket 260 sharing coupling 231, and fixture 232 including key 261. Unlike joist bracket 260, joist bracket 270 is instructive for showing a different pattern of fastener openings through coupling 231 and fixture 232, and for showing a different structural configuration for coupling 231. Rather an a generally U-shaped element, coupling 231 is an elongate generally tubular member 271 having a front wall 272 from which key 261 is formed laterally inward thereof, and having closed sides 273 and 274 formed with opposed inwardly directed flanges 275 and 276. Flanges 275 and 276 are formed rearward of front wall 272 and cooperate with front wall 272 forming a socket 277 therethrough for receiving fixture 232 and which extends from an upper end 278 of tubular member 271 to a lower end 279 of tubular member 271.

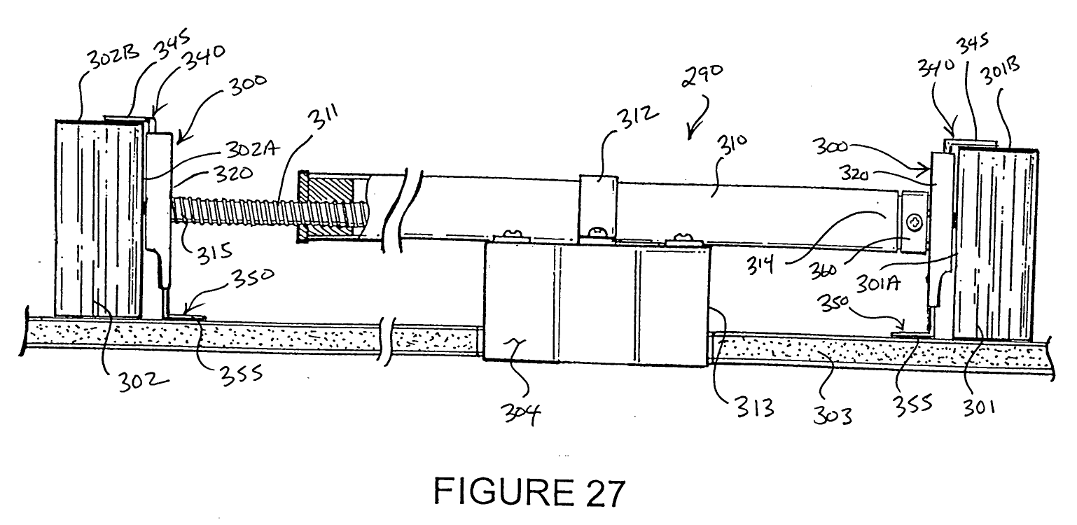

And now attention is directed to FIG. 27, which is a side elevational view of a hanger assembly 290 incorporating joist brackets 300 each constructed and arranged in accordance with the principle of the invention. Hanger assembly 290 is installed between parallel horizontal joists 301 and 302 and joist brackets 300 are affixed to joists 301 and 302 securing hanger assembly 290 in place. Joists 301 and 301 are in vertical cross section in the drawing in the vicinity of hanger assembly 290 for purposes of illustration. Ceiling 303 is supported by the lower sides of joists 301 and 302, and is penetrated by junction-box opening 304 affording access from the room below.

Hanger assembly 290 extends between joists 301 and 302 and includes an internally-threaded cylinder 310 and an externally-threaded rod 311 threadably received therein, in which rotation of one relative to the other functions to adjust the length of hanger assembly 290, which is a known arrangement in the art of inter-joist hangers. A junction box bracket 312 secures a junction box 313 to cylinder 310, in which box 313 is positioned at opening 304 and is available to be attached to a load, such as a ceiling fan. Cylinder 310 has an outer end 314 attached to one joist bracket 300 secured to joist 301, and rod 311 has an outer end 315 attached to another joist bracket 300 secured to joist 302. Joist brackets 300 are identical, and only one will now be discussed with the understanding that the ensuing discussion applies to each of joist brackets 300.

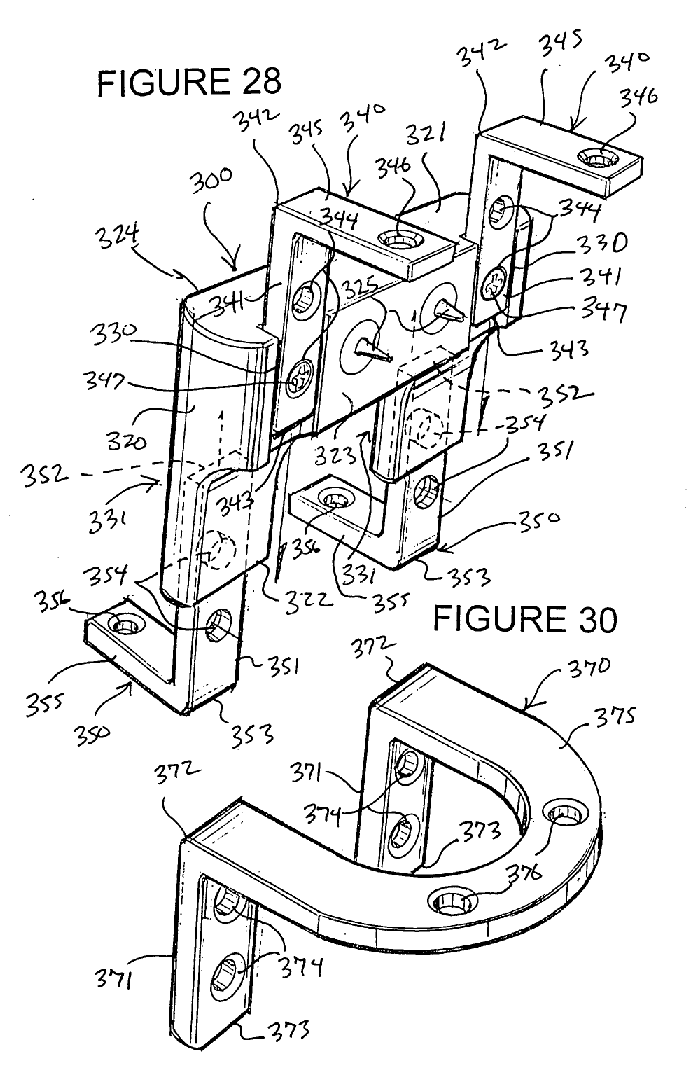

Referring to FIG. 28, joist bracket 300 includes a base 320 having an upper end 321, a lower end 322, a front face 323 and an opposing rear face 324. Formed into front face 323 at upper end 321 are opposed parallel ways 330 and 331, and formed into rear face 323 at lower end 322 are opposed parallel ways 331. Ways 330 are considered upper ways and ways 331 are considered lower ways. Teeth 325 are formed laterally inward of front face 323.

Joist bracket 300 incorporates joist attachment fixtures 340, and extensions 350. Joist attachment fixtures 340 are identical to one another each consisting of an upright member 341 having opposing upper and lower ends 342 and 343 and opposing fastener openings 344 extending therethrough, in which the fastener opening 344 positioned adjacent to upper end 342 is an upper fastener opening and the fastener opening 344 positioned adjacent to lower end 343 is the lower fastener opening. A generally horizontal member 345 formed with a fastener opening 346 is formed laterally inward of upper end 342. Upright members 341 of fixtures 340 are positioned in ways 330 and project upwardly from upper end 321 of base 320 to horizontal members 345, which project laterally inward of front face 323 of base 320.

Fixtures 340 are engagable to base 320 in extended positions as shown in FIG. 28 and also in retracted positions, which allows joist bracket 300 to be adjusted between extended and retracted configurations from upper end 321 of base 320. To engage fixtures 340 to base in their extended positions, the lower fastener openings 344 adjacent to lower ends 343 are aligned with corresponding fastener openings (not shown) extending into base 320 from ways 330 and fasteners 347, which in this instance are screws, are passed into the fastener openings in base 320 through the lower fastener openings 344 of upright members 341 securing fixtures 340 in place in their extended positions relative to upper end 321 of base 320. To engage fixtures 340 to base in their retracted positions, the upper fastener openings 344 adjacent to upper ends 342 are aligned with the corresponding fastener openings (not shown) extending into base 320 from ways 330 and fasteners 347 are passed into the fastener openings in base 320 through the upper fastener openings 344 of upright members 341 securing fixtures 340 in place in their retracted positions relative to upper end 321 of base 320.

Extensions 350 are identical to one another each consisting of an upright member 351 having opposing upper and lower ends 352 and 353 and opposing fastener openings 354 extending therethrough, in which the fastener opening 354 positioned adjacent to upper end 352 is an upper fastener opening and the fastener opening 354 positioned adjacent to lower end 353 is the lower fastener opening. A generally horizontal member 355 formed with a fastener opening 356 is formed laterally inward of upper end 352. Upright members 351 of extensions 350 are positioned in ways 331 and project downwardly from lower end 322 of base 320 to horizontal members 355, which project laterally outward of front face 323 of base 320.

Extensions 350 are engagable to base 320 in extended positions as shown in FIG. 28 and also in retracted positions, which allows joist bracket 300 to be adjusted between extended and retracted configurations from lower end 322 of base 320. To engage extensions 350 to base in their extended positions, the upper fastener openings 354 adjacent to upper ends 342 are aligned with corresponding fastener openings (not shown) extending into base 320 from ways 331 and fasteners, such as screws, are passed into the fastener openings in base 320 through the upper fastener openings 354 of upright members 351 securing extensions 350 in place in their extended positions relative to lower end 322 of base 320. To engage extensions 350 to base in their retracted positions, the lower fastener openings 354 adjacent to lower ends 343 are aligned with corresponding fastener openings (not shown) extending into base 320 from ways 331 and fasteners, such as screws, are passed into the fastener openings in base 320 through the lower fastener openings 354 of upright members 351 securing extensions 350 in place in their retracted positions relative to lower end 322 of base 320.

In FIG. 28, joist brackets 300 are affixed to joists 301 and 302 securing hanger assembly 290 in place. To install joist brackets 300 to joists 301 and 302, cylinder 310 is rotated relative to rod 311 causing hanger assembly 290 to lengthen forcibly presenting front faces 323 of joist brackets 300 against inner faces 301A and 302A of joists 301 and 302, the latter being penetrated by teeth 325. In FIG. 28, joists 301 and 302 are exemplary of 2×4 joists, and fixtures 340 are disposed in their retracted positions, in which members 345 of fixtures 340 are positioned atop the top edges/sides 301B and 302B of joists 301 and 302 and members 355 of extensions 350 are positioned against the underside of ceiling 303. Members 345 and 355 bear the load applied to hanger assembly 290 from a load, such as a ceiling fan, attached to junction box 313. Members 345 are secured in place with fasteners, such as screws, which are passed into and through the top sides 301B and 302B of joists 301 and 302 through fastener openings 346. Members 355 are secured in place with fasteners, such as screws, which are passed into and through ceiling 303 from the underside thereof through fastener openings 356.

And so fixtures 345 and extensions 355 can be adjusted back and forth from their extended and retracted positions for adjusting the length of joist brackets 300 allowing them to be installed with 2×4 joists, 2×6 joists, and other sizes of joists for permitting members 345 of fixtures 340 to be positioned atop and secured to the top sides of the joists and for permitting members 355 of extensions 350 to be positioned against the underside of the ceiling adjacent to the joists. Adjusting the lengths of the joist brackets 300 between extended and retracted configurations also allows the height of cylinder 310 relative to a junction box opening to be adjusted for positioned a junction box mounted thereto at desired location relative to the junction box opening.

As seen in FIG. 27, end 315 of rod 311 is threadably secured to rear face 324 of base 320 of its joist bracket 300, and end 314 of cylinder 310 is journaled to rear face 324 of base 320 of its joist bracket 300 with a conventional journal coupling 360. This arrangement is common and allows cylinder 310 to be rotated relative to rod 311 for adjusting the length of hanger assembly 290.

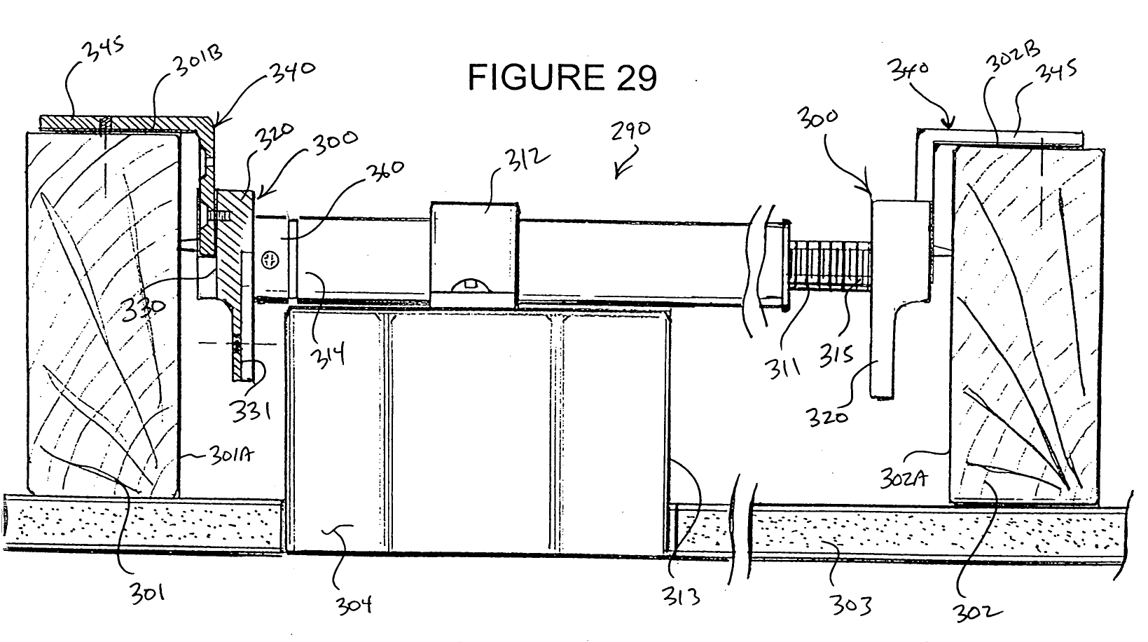

Because fixtures 340 and extensions 350 are removably attached, they may be used independently from one another if desired, in which case only extensions 350 may be used to secure a hanger assembly in place or only fixtures 350 may be used to secure a hanger assembly in place. As a matter of example, FIG. 29 illustrates hanger assembly 290 as it would appear with joist brackets 300 secured in place to joists 301 and 302 with fixtures 340. In FIG. 29, extensions 350 are removed and not used.

Brackets constructed and arranged in accordance with bracket 300 may be used in conjunction with any inter-joist hanger assembly, including all of the hanger assemblies herein disclosed. Furthermore, although brackets 300 each incorporate two fixtures and two extensions, less or more may be used, if desired. Furthermore, although brackets 300 each incorporate two fixtures, the fixtures may be joined together to be a single-piece fixture, and just such a fixture 370 is shown in FIG. 30 as a matter of example. Bracket 370 includes opposing upright members 371 having opposing upper and lower ends 372 and 373 and opposing fastener openings 374 extending therethrough, in which the fastener openings 374 positioned adjacent to upper ends 3742, respectively, are upper fastener openings, and the fastener opening 374 positioned adjacent to lower ends 373, respectively, are the lower fastener openings. A generally horizontal U-shaped member 375 formed with fastener openings 376 is formed laterally inward of upper ends 372. Upright members 371 are positionable in ways 330 of base 320 shown in FIG. 28 to project upwardly from upper end 321 of base 320 to horizontal U-shaped members 375 to project laterally inward of front face 323 of base 320. Such a fixture may also be used in lieu of extensions 350, if desired.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A hanger assembly, comprising:
a tubular member attached to a first joist bracket and severed along a length thereof forming an end gap therein;
an insert attached to a second joist bracket and extending into and through the tubular member; and
the tubular member movable into a collapsed configuration in response to a force applied thereto at least partially closing the end gap grippingly securing the insert extending therethrough.

2. The hanger assembly according to claim 1, further comprising:
a junction box; and
a hanger bracket coupling the junction box the tubular member.

3. The hanger assembly according to claim 2, further comprising:
the hanger bracket having a central portion overlying the elongate tubular member at the end gap and opposing ends affixed to the junction box; and
the central portion applying the force to the tubular member.

4. The hanger assembly according to claim 1, further comprising:
one of a key and a keyhole carried by the first joist bracket;
the other of the key and the keyhole carried by the tubular member;
the key received in the keyhole.

5. The hanger assembly according to claim 1, the first joist bracket comprising:
a first coupling attached to the tubular member;
a first joist attachment fixture engagable to the first coupling in a retracted position relative to the first coupling and an extended position relative to the first coupling; and
the first joist attachment fixture engaged to the first coupling in one of the retracted position and the extended position.

6. The hanger assembly according to claim 1, the second joist bracket comprising:
a second coupling attached to the insert; and
a second joist attachment fixture engagable to the second coupling in a retracted position relative to the second coupling and an extended position relative to the second coupling; and
the second joist attachment fixture engaged to the second coupling in one of the retracted position and the extended position.

7. The hanger assembly according to claim 1, further comprising:
the first and second joist brackets affixed to opposing joists positioned on an underside of a ceiling; and
the first and second joist brackets having first and second extensions, respectively, positioned against the underside of the ceiling.

8. The hanger assembly according to claim 7, further comprising:
the first joist bracket having a first base attached to the tubular member;
the first extension engagable to the first base in a retracted position relative to the first base and an extended position relative to the first base; and
the first extension engaged to the first base in one of the retracted position and the extended position.

9. The hanger assembly according to claim 7, further comprising:
the second joist bracket having a second base attached to the tubular member;
the second extension engagable to the second base in a retracted position relative to the second base and an extended position relative to the second base; and
the second extension engaged to the second base in one of the retracted position and the extended position.

10. A hanger assembly, comprising:
a tubular member attached to a first joist bracket and severed along a length thereof forming an end gap therein;
an insert attached to a second joist bracket and extending into and through the tubular member;
the tubular member movable into a collapsed configuration in response to a force applied thereto at least partially closing the end gap grippingly securing the insert extending therethrough;
a junction box;
a hanger bracket having a central portion overlying the elongate tubular member and opposing ends affixed to the junction box; and
the central portion of the hanger bracket applying the force to the tubular member.

11. The hanger assembly according to claim 10, further comprising:
one of a key and a keyhole carried by the first joist bracket;
the other of the key and the keyhole carried by the tubular member;
the key received in the keyhole.

12. The hanger assembly according to claim 10, the first joist bracket comprising:
a first coupling attached to the tubular member;
a first joist attachment fixture engagable to the first coupling in a retracted position relative to the first coupling and an extended position relative to the first coupling; and
the first joist attachment fixture engaged to the first coupling in one of the retracted position and the extended position.

13. The hanger assembly according to claim 10, the second joist bracket comprising:
a second coupling attached to the insert; and
a second joist attachment fixture engagable to the second coupling in a retracted position relative to the second coupling and an extended position relative to the second coupling; and
the second joist attachment fixture engaged to the second coupling in one of the retracted position and the extended position.

14. The hanger assembly according to claim 10, further comprising:
the first and second joist brackets affixed to opposing joists positioned on an underside of a ceiling; and
the first and second joist brackets having first and second extensions, respectively, positioned against the underside of the ceiling.

15. The hanger assembly according to claim 14, further comprising:
the first joist bracket having a first base attached to the tubular member;
the first extension engagable to the first base in a retracted position relative to the first base and an extended position relative to the first base; and
the first extension engaged to the first base in one of the retracted position and the extended position.

16. The hanger assembly according to claim 14, further comprising:
the second joist bracket having a second base attached to the tubular member;
the second extension engagable to the second base in a retracted position relative to the second base and an extended position relative to the second base; and
the second extension engaged to the second base in one of the retracted position and the extended position.

17. A hanger assembly, comprising:
a first tubular member attached to a first joist bracket and severed along a length thereof forming a first end gap therein between opposing first and second edges thereof formed with first and second stops, respectively;
a second tubular member attached to a second joist bracket and extending into and through the first tubular member and severed along a length thereof forming a second end gap therein between opposing third and fourth edges thereof opposing the first and second stops, respectively; and
the first and second tubular members movable into a collapsed configuration in response to a force applied thereto at least partially closing the first and second end gaps and bringing the first and second stops into forcible engagement against the third and fourth edges, respectively, of the second tubular member and forcibly exerting the inner surface of the first tubular member against the outer surface of the second tubular member thereby frictionally securing the inner surface of the first tubular member to the outer surface of the second tubular member.

18. The hanger assembly according to claim 17, further comprising:
a junction box; and
a hanger bracket coupling the junction box the tubular member.

19. The hanger assembly according to claim 18, further comprising:
the hanger bracket having a central portion overlying the elongate tubular member at the end gap and opposing ends affixed to the junction box; and
the central portion applying the force to the tubular member.

20. The hanger assembly according to claim 18, further comprising a spacer disposed between the junction box and the hanger bracket.
